(19) United States
(12) Patent Application Publication
(10) Pub. No.: US 2005/0056133 A1
(43) Pub. Date: Mar. 17, 2005

(54) Paper punch pin

(76) Inventor: Chien-Kai Huang, Chang Hua City (TW)

Correspondence Address: BACON & THOMAS, PLLC, 625 SLATERS LANE, FOURTH FLOOR, ALEXANDRIA, VA, 22314, US

(21) Appl. No.: 10/662,277

(22) Filed: Sep. 16, 2003

(51) Int. Cl. B26D 5/08; B26F 1/14

(52) U.S. Cl. 83/686; 83/588; 83/636

(57) ABSTRACT

A punch pin includes three terminal ends extending from a periphery of an end of the body and each terminal end has a tip portion located between two cutting edges, A groove is defined in the end having the terminal ends and enclosed by the three terminal ends. The three respective tip portions are located at three parallel planes which are perpendicular to a longitudinal axis of the cylindrical body. The groove includes an upper curved surface, a curved area and three inner surfaces of the three terminal ends. The upper curved surface connects the curved area. The peak force for punching a stack of paper is less than conventional punch pin and the resistant force coming from the deformation of the paper being punched out.

### FIELD OF THE INVENTION

The present invention relates to a paper punch pin having three terminal ends located at three different planes so as to reduce the peak force required when punching a stack of paper.

### BACKGROUND OF THE INVENTION

A conventional paper punch is shown in FIGS. 1 and 2 and generally includes a punch frame 10 having a horizontal member 13 having a first opening 131, a paper thickness limit member 12 having a second opening 121, and a punch base 11 having an outlet opening 111 which is located in alignment with the first and second holes 131, 121. A punch pin 20 movably extends through the first hole 131 and the second hole 121, and a drive member 30 is in contact with the top of the punch pin 20 so as to lower the lower end of the punch pin 20 to punch through a stack of paper “a” which is inserted between the paper thickness limit member 12 and the punch base 11. The lower end of the punch pin 20 includes two terminal ends 22 and an invert V-shaped groove 21 is defined between the two terminal ends 22. Each terminal end 22 is connected to a flat side surface 23 and an upper curved surface 24 is connected to the two flat side surfaces 23. Referring to FIG. 3, it is to be noted that when the punch pin 20 is lowered, the two terminal ends 22 touch the paper simultaneously and this requires a larger force to penetrate the two terminal ends 22 through the stack of paper “a”. Furthermore, the paper being punched out “b” accommodated in the inverted V-shaped groove 21 and the flat side surfaces 23 is forced to deform into inverted V-shaped. This means that there is a resistant force applied to the flat side surfaces 23 when the paper being punched out “b” is forced to deform. The resistant force increases the total resistant force to against the punching force and reduces the lift term of use of the punch pin 20.

The present invention intends to provide a punch pin that requires less peak force and the resistant force from the punched paper is reduced.

### SUMMARY OF THE INVENTION

In accordance with one aspect of the present invention, there is provided a punch pin comprising a cylindrical body having a first end and a second end. Three terminal ends extend from a periphery of the second end of the body and each terminal end has a tip portion. A groove is defined in the second end of the body and enclosed by the three terminal ends. The three respective tip portions are located at three parallel planes which are perpendicular to a longitudinal axis of the cylindrical body. The three terminal ends each have an inner surface and two cutting edges between which the tip portion is located. A recess connects the two cutting edges of any two adjacent terminal ends. Each cutting edge has an edge surface which has a first angle α between 30 to 80 degrees relative to the longitudinal axis of the cylindrical body. The groove includes an upper curved surface, a curved area and the three inner surfaces. The upper curved surface connects the curved area. A second angle β between 15 to 40 degrees are defined between the inner surface of each terminal end and the longitudinal axis of the cylindrical body.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional punch pin in a paper punch;

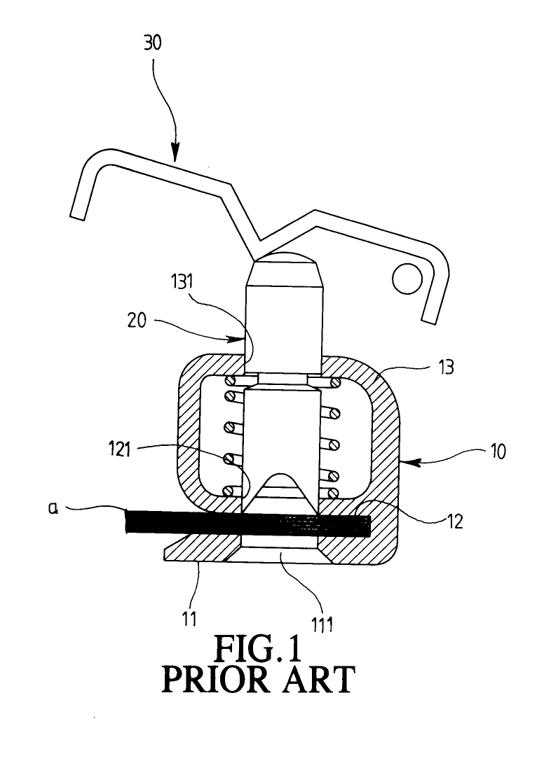

FIG. 2 shows a side view of the conventional punch pin;

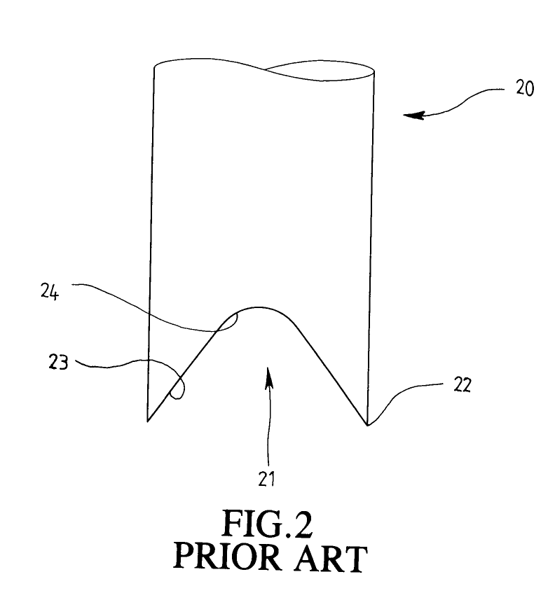

FIG. 3 shows continuous punching actions of the conventional punch pin;

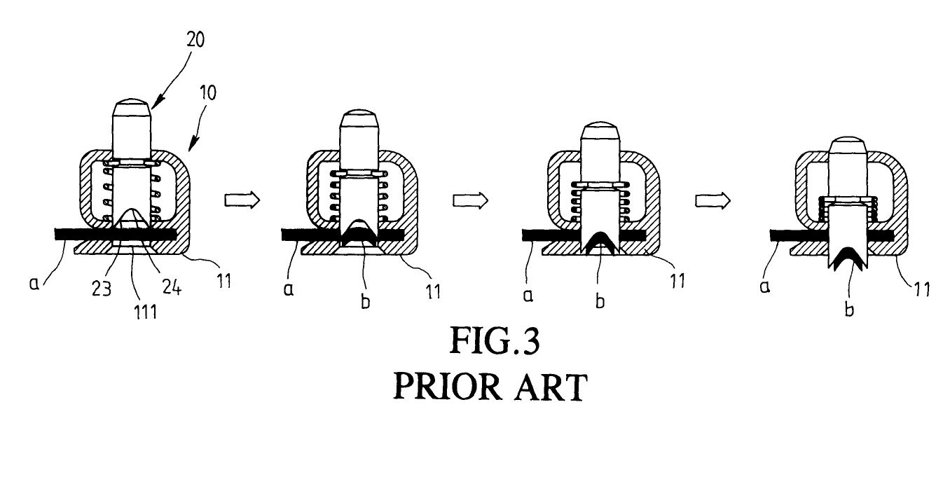

FIG. 4 is a perspective view to show the punch pin of the present invention;

FIG. 5 shows a cross sectional view of the punch pin of the present invention;

FIG. 6 shows the bottom view of the punch pin of the present invention;

FIGS. 7A and 7B show two different embodiments of the first angle α of the punch pin of the present invention;

FIGS. 8A and 8B show two different embodiments of the second angle β of the punch pin of the present invention;

FIG. 9 shows the height of the three terminal ends of the punch pin of the present invention;

FIG. 10 shows continuous punching actions of the punch pin of the present invention, and

FIG. 11 shows the paper being punched out by the punch pin of the present invention.

### DETAILED DESCRIPTION OF THE PREFERRED EMBODIMENT

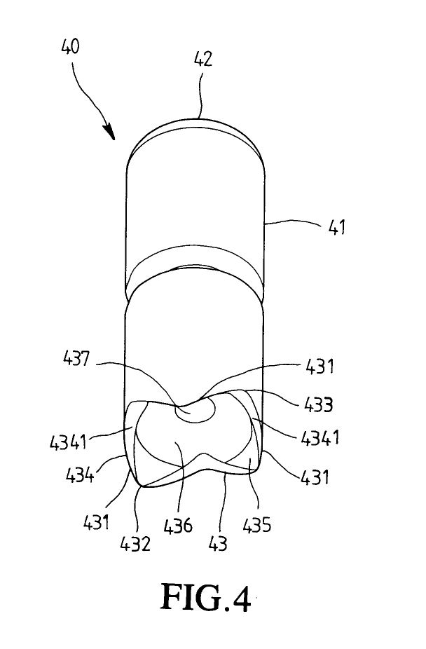

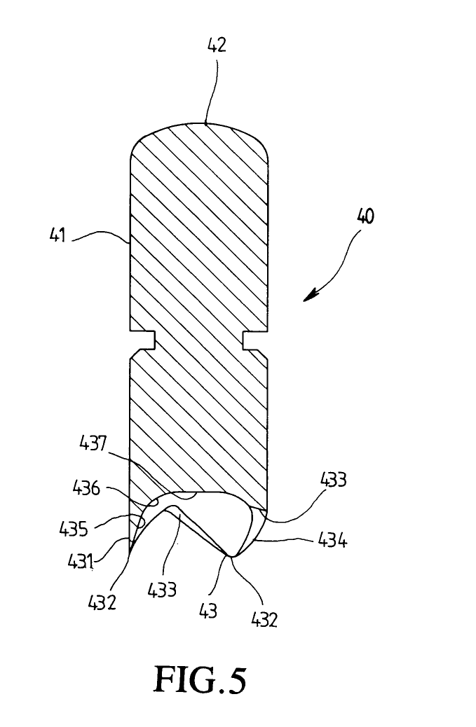

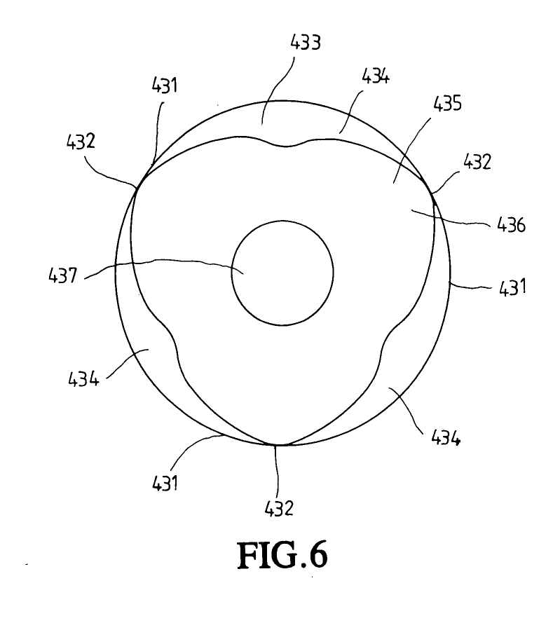

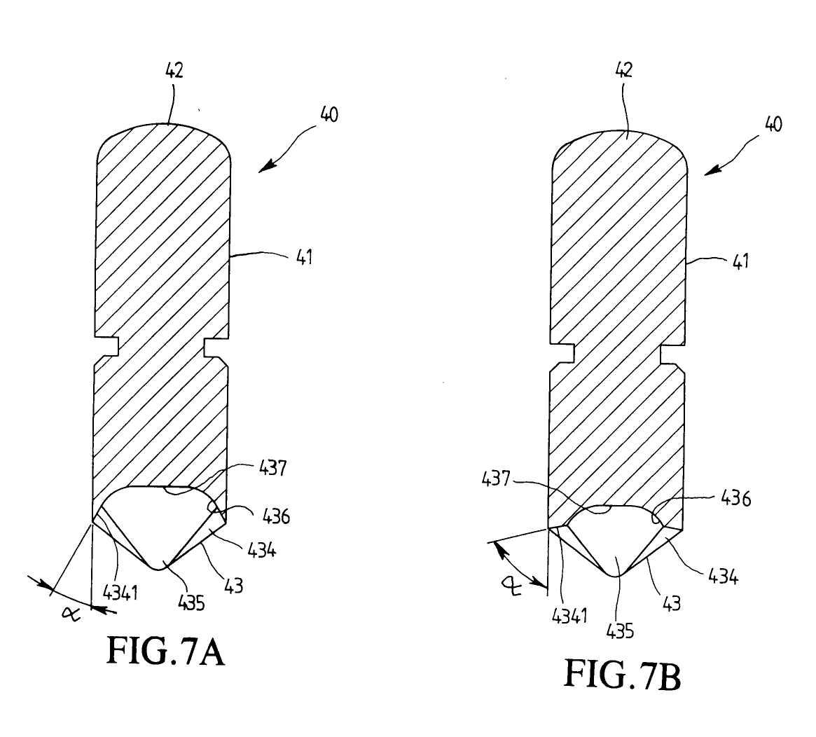

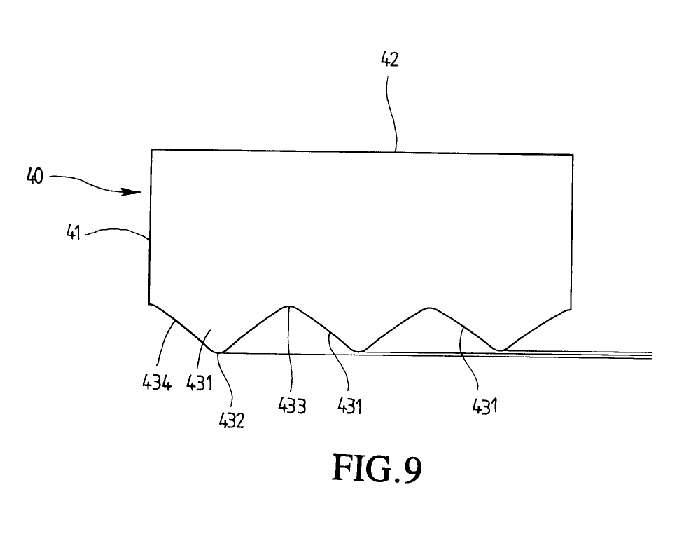

Referring to FIGS. 4 to 6, the punch pin 40 of the present invention comprises a cylindrical body 41 having a first end 42 and a second end 43. The first end 42 is in contact with a drive member which is not shown and the second end 43 includes three terminal ends 431 extending from a periphery of the second end 43 of the body 41 at equal angular. Each terminal end 431 has a tip portion 432 and a groove is defined in the second end 43 of the body 41 and enclosed by the three terminal ends 431. The three respective tip portions 432 are located at three parallel planes which are perpendicular to a longitudinal axis of the cylindrical body 41 as shown in FIG. 9, such that when punching a stack of paper, the three terminal ends 431 touch the stack of paper one by one so as to concentrate the force to penetrate the paper. The three terminal ends 431 each have an inner surface 435 and two cutting edges 434. The tip portion 432 is connected between the two cutting edges 434. A recess 433 connects the two cutting edges 434 of any two adjacent terminal ends 431. Each cutting edge 434 has an edge surface 4341 which has a first angle α relative to the longitudinal axis of the cylindrical body 41, and the first angle α decides the thickness of the terminal end 431 and is located in a range between 30 to 80 degrees as shown in FIGS. 7A and 7B.

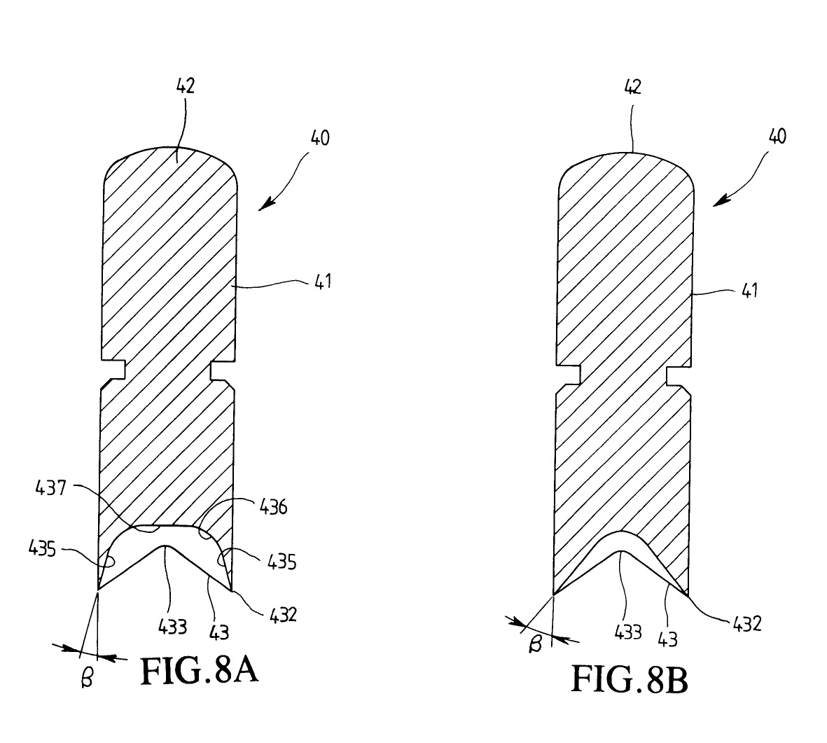

The groove includes an upper curved surface 437, a curved area 436 and the three inner surfaces 435, wherein the upper curved surface 437 connects the curved area 436. A second angle β is defined between the inner surface 435 of each terminal end 431 and the longitudinal axis of the cylindrical body 41. The second angle β decides the sharpness of each terminal end 431 and is located in a range from 15 to 40 degrees as shown in FIGS. 8A and 8B.

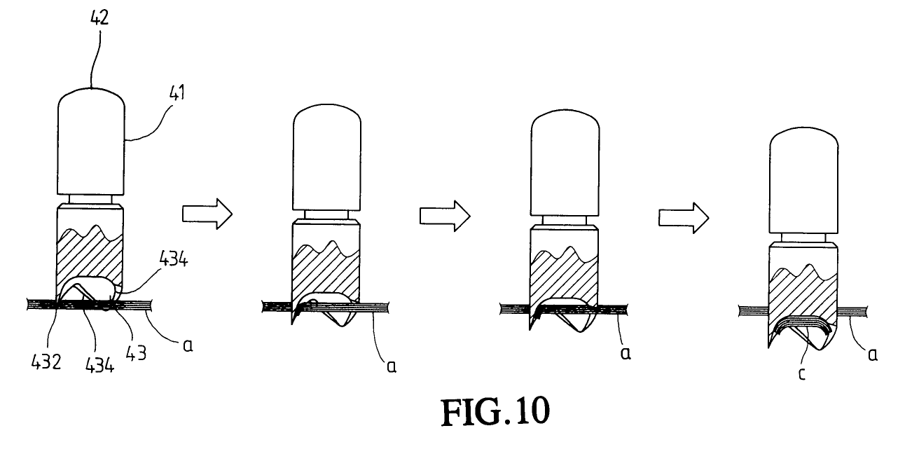

Preferably, the three respective heights of the three respective terminal ends 431 from the recess to the tip portion 432 are 2.4 mm, 2.26 mm and 2.1 mm respectively. Accordingly, as shown in FIG. 10, when the first terminal end 431 touches the stack of paper “a”, all the punching force is applied to the only terminal end 431 so that the terminal end 431 easily penetrates the paper. The rest of two terminal ends 431 then touch the stack of paper “a” in sequence. This requires less force to punch the stack of paper “a”.

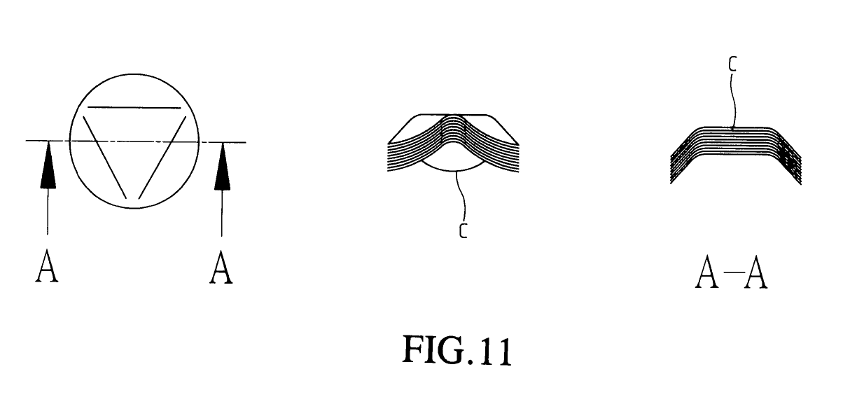

A radius of the curved area 436 is preferable to be 19.83 mm and a radius of the upper curved surface 437 is preferable to be 0.75 mm. The two radiuses of the groove allow the paper being punched out “c” to be deformed much smaller than that in conventional punch pin as described above. As seen in FIG. 11, the paper being punched out “c” does not deform severely in the longitudinal direction because the space in the groove is wide enough so that the three terminal ends 431 are suffered less resistant force coming from the paper being punched out “c”. This increases the term of use of the punch pin 40.

While we have shown and described the embodiment in accordance with the present invention, it should be clear to those skilled in the art that further embodiments may be made without departing from the scope of the present invention.

1. A punch pin comprising:
a cylindrical body having a first end and a second end, three terminal ends extending from a periphery of the second end of the body and each terminal end having a tip portion, a groove defined in the second end of the body and enclosed by the three terminal ends, the three respective tip portions being located at three parallel planes which are perpendicular to a longitudinal axis of the cylindrical body, the three terminal ends each having an inner surface and two cutting edges, the tip portion connected between the two cutting edges, a recess connecting the two cutting edges of any two adjacent terminal ends, each cutting edge having an edge surface which has a first angle α relative to the longitudinal axis of the cylindrical body, the groove including an upper curved surface, a curved area and the three inner surfaces, the upper curved surface connecting the curved area, a second angle β being defined between the inner surface of each terminal end and the longitudinal axis of the cylindrical body.

2. The punch pin as claimed in claim 1, wherein the first angle α is located in a range from 30 to 80 degrees.

3. The punch pin as claimed in claim 1, wherein the second angle β is located in a range from 15 to 40 degrees.

4. The punch pin as claimed in claim 1, wherein a radius of the curved area is 19.83 mm.

5. The punch pin as claimed in claim 1, wherein a radius of the upper curved surface is 0.75 mm.

6. The punch pin as claimed in claim 1, wherein three respective heights of the three respective terminal ends from the recess to the tip portion are 2.4 mm, 2.26 mm and 2.1 mm respectively.
